(19) United States
(12) Patent Application Publication
(10) Pub. No.: US 2026/0338351 A1
(43) Pub. Date: Oct. 29, 2026

(54) PROJECTOR AND METHOD FOR PRODUCING OPTICAL ELEMENTS FOR A PROJECTOR

(71) Applicant: ams-OSRAM International GmbH, Regensburg (DE)

(72) Inventor: Ho Hoai Duc NGUYEN, München (DE)

(21) Appl. No.: 19/102,455

(22) PCT Filed: Jul. 20, 2023
(86) PCT No.: PCT/EP2023/070149

§ 371 Date: Feb. 10, 2025

(30) Foreign Application Priority Data
Aug. 12, 2022 (DE) 10 2022 120 429.4

(51) Int. Cl. F21V 5/00; F21S 43/14; F21S 43/20; F21W 103/60; F21Y 113/00

(52) U.S. Cl. CPC F21V 5/007; F21S 43/14; F21S 43/26411; F21W 2103/60; F21Y 2113/00

(57) ABSTRACT

A projector—for projecting an image onto a surface includes a radiation-emitting device having a plurality of radiation-emitting units, and a projection arrangement for projecting the radiation emitted by the radiation-emitting device onto the surface. The radiation-emitting units are configured to emit radiation. The projection arrangement includes a plurality of projection channels. Each projection channel has an optical element for beam shaping. Each projection channel is configured to project radiation incident on the projection channel into a certain area of the surface. At least some radiation-emitting units of the radiation-emitting device are uniquely assigned to a projection channel so radiation from the assigned radiation-emitting unit is at least predominantly incident on the respective projection channel. At least some radiation-emitting units are controllable independently of other radiation-emitting units so different images can be projected onto the surface by changing the control of the radiation-emitting units without changing the projection arrangement.

A projector for projecting an image onto a surface is specified. Furthermore, a method for producing optical elements for a projector is specified.

One object to be achieved is to provide an improved projector, for example a particularly compact projector. A further object to be achieved is to provide an improved method for producing optical elements, particularly for such a projector.

Firstly, the projector for projecting an image onto a surface is specified.

According to at least one embodiment, the projector for projecting an image onto a surface comprises a radiation-emitting device. The radiation-emitting device comprises a plurality of radiation-emitting units. The radiation-emitting device is, for example, configured to produce and emit visible light. By way of example, the radiation-emitting device comprises at least four or at least 10 or at least 100 or at least 10000 or at least 1 million radiation-emitting units. The radiation-emitting units are also called image points or pixels.

According to at least one embodiment, the projector comprises a projection arrangement for projecting the radiation emitted by the radiation-emitting device onto the surface. Particularly, the projection arrangement is configured to redirect and/or focus and/or disperse the radiation emitted by the radiation-emitting device by means of reflection, refraction and/or diffraction.

The surface, onto which the radiation is projected, may be a screen or a wall or a glass plate or a street. The projector may be used in a beamer or in a vehicle, like a car. The projector may be arranged in the vehicle and may be configured to project an image onto the street in front of the door when a passenger enters or exits the vehicle via said door. For example, the projector projects a brand of the vehicle onto the street. The projector could also be used in the interior of a vehicle and may project an image onto a surface in the interior of the vehicle. For example, the projector is then used for decorative or functional lighting. The projector may also be used to realize a head-up display. For example, the projector then projects an image onto the windshield of the vehicle.

According to at least one embodiment, the radiation-emitting units are each configured to emit radiation when operated. For example, the radiation-emitting device comprises a radiation surface, via which the major part or all of the radiation emitted by the radiation-emitting device is emitted. The radiation-emitting units may be laterally arranged next to each other, wherein a lateral direction is a direction parallel to the radiation surface. The radiation-emitting units may be arranged in a two-dimensional pattern. For example, each radiation-emitting unit is assigned an area of the radiation surface on a one-to-one basis. Thus, when a radiation-emitting unit emits radiation, radiation is emitted via the assigned area of the radiation surface.

A radiation-emitting device comprising a plurality of radiation-emitting units is herein understood to be a device which itself generates the radiation and emits the radiation via the radiation-emitting units. Particularly, each radiation-emitting unit is assigned a certain area of the radiation-emitting device on a one-to-one basis, wherein radiation is generated within said area and/or emitted via said area.

According to at least one embodiment, the projection arrangement comprises a plurality of projection channels. Each projection channel has at least one optical element for beam shaping. The optical element is, for example, a lens or an optical aperture or a mirror or a prism. Each projection channel having at least one optical element particularly means that different projection channels comprise different optical elements. For example, each projection channel has at least one optical element, like a lens, uniquely assigned to that projection channel. Optical elements of different projection channels may be separated, for example spaced, from each other. Alternatively, the optical elements of different projection channels may be connected and may even be formed in one piece.

According to at least one embodiment, each projection channel is configured to project radiation, particularly radiation from the radiation-emitting device, incident on or into the projection channel, respectively, into a certain area of the surface.

Each projection channel may comprise two or more optical elements which are, for example, arranged one after the other along the optical path of the projection channel. The optical path of the projection channel is the path along which the radiation is guided within the projection channel. The projection channels may be arranged next to each other in a direction oblique or perpendicular to the optical paths.

The projection channels are, in particular, configured to project radiation onto different areas of the surface. Thus, each projection channel may be uniquely assigned a certain area of the surface, wherein each two areas assigned to different projection channels do not overlap or at least do not completely overlap.

According to at least one embodiment, at least some, for example all, radiation-emitting units of the radiation-emitting device are each uniquely assigned to a projection channel such that radiation from the radiation-emitting unit is at least predominantly, for example solely, incident on or into the respective projection channel. The projection arrangement may comprise the same number of projection channels as the radiation-emitting device comprises radiation-emitting units.

With the radiation-emitting units being each uniquely assigned to a projection channel, each radiation-emitting unit may be uniquely assigned to an image point or pixel of the image projected onto the surface.

According to at least one embodiment, at least some radiation-emitting units are controllable independently of other radiation-emitting units. Thus, different images can be projected onto the surface by changing the control of the radiation-emitting units without changing the projection arrangement.

By controlling a radiation-emitting unit, the radiation-emitting unit is operated, i.e. generates and emits radiation. Two radiation-emitting units are controllable independently of each other, if one of the two radiation-emitting units can be operated such that it emits radiation while, at the same time, the other radiation-emitting unit is turned off, i.e. does not emit radiation.

In at least one embodiment, the projector for projecting an image onto a surface comprises a radiation-emitting device having a plurality of radiation-emitting units and a projection arrangement for projecting the radiation emitted by the radiation-emitting device onto the surface. The radiation-emitting units are each configured to emit radiation when operated. The projection arrangement comprises a plurality of projection channels, each projection channel having at least one optical element for beam shaping. Each projection channel is configured to project radiation incident on the projection channel into a certain area of the surface. At least some radiation-emitting units of the radiation-emitting device are each uniquely assigned to a projection channel such that radiation from the assigned radiation-emitting unit is at least predominantly incident on the respective projection channel. At least some radiation-emitting units are controllable independently of other radiation-emitting units so that different images can be projected onto the surface by changing the control of the radiation-emitting units without changing the projection arrangement.

Projectors normally comprise a single light source, the light of which is incident on a projection arrangement. The projection arrangement may comprise a mask with opaque and transparent areas and thereby defines the image which is projected onto a surface. In this case, the image is fixed and cannot be changed.

On the other hand, there are projectors which use one single light source, like an LED, and the radiation thereof is incident on a projection arrangement in the form of a DMD (Digital Micromirror Device) or in the form of an LCD (Liquid Crystal Display). The micro mirrors of the DMD are movable independently of each other. The beam of the light source is then split into several beams by the movable micromirrors and then reflected in order to project an image onto a surface. This approach is expensive and requires a complicated mirror control.

Laser projectors are also known, in which a laser beam is redirected with the help of a movable mirror. With the help of the mirror, the image is projected onto a projection surface row by row.

The present invention is, inter alia, based on the recognition that by using a radiation-emitting device or light source, respectively, which itself already comprises a plurality of radiation-emitting units, the distance of the radiation-emitting device to the projection arrangement can be reduced. Indeed, in projectors using a radiation source with only one radiation-emitting unit, the radiation has first to be dispersed in order to get a sufficiently large beam spot for a projection arrangement. Dispersing requires collimation optics arranged between the radiation source and the projection arrangements. Thus, additional space is required between the radiation source and the projection arrangement.

By using a radiation-emitting device which already comprises a plurality of radiation-emitting units, collimation optics can be dismissed so that the extensions of the projector can be reduced. This can be particularly beneficial when using such a projector in a vehicle, where space is limited.

According to at least one embodiment, the projection arrangement comprises a lens array, e.g. a microlens array. At least some of the radiation-emitting units have a lens of the lens array uniquely assigned thereto. A lens of the lens array being uniquely assigned to a radiation emitting unit means that at least a major part of the radiation emitted by that radiation-emitting unity hits onto the respective lens. The lens array may comprise as much lenses as the radiation-emitting device comprises radiation-emitting units.

The lenses of the lens array may be arranged in the projection channels. For example, at least some or all lenses of the lens array are each uniquely assigned to a projection channel. For example, the diameter of a projection channel is determined by the largest diameter of a lens uniquely assigned to that projection channel.

A lens array is a structure comprising a plurality of lenses mechanically connected and fixed to each other. The lenses of the lens array are arranged, for example, in a two-dimensional pattern constituting a layer of lenses. The lens axes of the lenses are each orientated obliquely or perpendicularly to the layer, for example. A microlens is herein understood as a lens having a diameter of at most 1 mm or at most 100 μm or at most 50 μm. The lenses of the lens array may be focusing lenses or dispersing lenses. For example, the lenses of the lens array are arranged on a common substrate. The substrate is, in particular, transparent for the radiation of the radiation-emitting device.

According to at least one embodiment, the projection arrangement comprises two or more lens arrays, particularly microlens arrays, which are arranged one after the other. “One after the other” particularly means one after the other in a direction along the optical paths of the projection channels. All features disclosed so far and in the following for one lens array are also disclosed for the other lens arrays. Two lens arrays, namely the lenses thereof, may be arranged on opposite sides of a common substrate.

According to at least one embodiment, at least some projection channels, for example all projection channels, each have at least two lenses of different lens arrays uniquely assigned thereto. Both lenses may be microlenses. The lenses assigned to a projection channel are, for example, arranged one after the other in a direction parallel to the optical path of the respective projections channels. Thus, radiation incident on the radiation channel first hits one of the at least two lenses and, afterwards, hits the other one of the at least two lenses.

For example, at least some or all of the projection channels each comprise at least one focusing lens and at least one dispersing lens.

According to at least one embodiment, the projection arrangement comprises several optical apertures. An optical aperture is herein particularly understood to be an opening in an opaque element, wherein radiation can pass through the opening.

According to at least one embodiment, at least some of the projection channels, for example all projection channels, each have an optical aperture uniquely assigned thereto.

At least some optical apertures may be formed in a common opaque element of the projection arrangement. For example, the projection arrangement comprises a contiguous, opaque layer which is interrupted by a plurality of openings, wherein each opening constitutes an optical aperture. The opaque layer may be formed of chrome, for example. The opaque layer may be formed on or in the common substrate, on which the lenses of at least one lens array are arranged.

By way of example, the optical apertures assigned to the different projection channels are in each case arranged between the at least two lenses of the respective projection channel in a direction along the optical path of the respective projection channel.

According to at least one embodiment, the radiation-emitting device comprises a plurality of LEDs. Each LED is or comprises a LED-chip or optoelectronic semiconductor chip, respectively. Semiconductor bodies of different LEDs are separated and spaced from each other. For example, the LEDs are mounted on a common carrier. The LEDs may also be electrically connected to the common carrier.

According to at least one embodiment, each LED is uniquely assigned to a radiation-emitting unit. Thus, the radiation emitted by a radiation-emitting unit is at least partially produced by the assigned LED.

According to at least one embodiment, at least two LEDs are uniquely assigned to each radiation-emitting unit. Thus, the radiation emitted by such a radiation-emitting unit is at least partially produced by one or both assigned LEDs.

According to at least one embodiment, the at least two LEDs are configured to emit different types of radiation, i.e. radiation of different wavelengths. For example, each radiation-emitting unit is assigned a first LED configured to emit radiation of a first color, like blue light, and a second LED configured to emit radiation of a second color, like green light or red light. Each radiation-emitting unit may also be assigned a third LED configured to emit radiation of a third color, like green light. Particularly, each radiation-emitting unit may be assigned at least three LEDs which are configured to emit different types of radiation, for example blue light, green light and red light.

Thus, the different radiation-emitting units of the radiation-emitting device may each be realized by at least one or at least two, for example by three, different LEDs. Alternatively, the radiation-emitting device may be realized by one single, pixelated LED having one contiguous semiconductor body. The different radiation-emitting units may each be uniquely assigned a region of the semiconductor body.

According to at least one embodiment, each LED is a μLED, also called “micro-LED”. A micro-LED is a light emitting diode (LED), particularly not a laser, with a particularly small size. A growth substrate for the semiconductor layer sequence of the micro-LED is removed from the micro-LED so that a height/thickness of a micro-LED is in the range of 1.5 μm to 10 μm, for example. In principle, a micro-LED could, but does not necessarily have to, have a rectangular radiation emission surface. For example, a micro-LED has a radiation emission surface in which, in plan view of the layers of the layer stack, any lateral extent of the radiation emission surface is less than or equal to 100 μm or less than or equal to 70 μm. For example, in the case of a rectangular micro-LED, an edge length—especially in plan view of the layers of the layer stack—may be smaller than or equal to 70 μm or smaller than or equal to 50 μm.

According to at least one embodiment, each radiation-emitting unit is independently controllable of the other radiation-emitting units. Thus, each radiation-emitting unit can emit radiation independently of the other radiation-emitting units. For example, each radiation-emitting unit is uniquely assigned a switch, like a thin-film transistor, TFT for short. The switches may be arranged in or on the common carrier. With the help of the switches, the different radiation-emitting units can be controlled, e.g. turned on or off.

For example, the projector is programmable so that various and arbitrary images can be produced with the radiation-emitting device. Alternatively, a limited number of images can be predefined so that only these images can be produced by the radiation-emitting device.

According to at least one embodiment, the projection arrangement is static. This means that, during operation, the properties of the projection arrangement, particularly the properties, positions, orientations and/or relative arrangements of the optical elements of the projection arrangement are not changed. A variation of the projected image is, for example, achieved or achievable, particularly solely achieved or achievable, by a variation of the control of the radiation-emitting units.

The projector may comprise a control unit for controlling the different radiation-emitting units.

According to at least one embodiment, the projection arrangement comprises a plurality of primary lenses. A primary lens is herein understood to be a first lens of the projection arrangement onto which radiation emitted by the radiation-emitting device hits. For example, no optical element, or at least no lens, is arranged between a primary lens and the assigned radiation-emitting device.

According to at least one embodiment, each primary lens is assigned a radiation-emitting unit, e. g. on a one-to-one basis. The primary lenses may be part of a lens array. The primary lenses may be microlenses and, accordingly, the lens array may be a microlens array.

According to at least one embodiment, the primary lenses are arranged immediately downstream of the assigned radiation-emitting units. “Downstream” here means downstream in a direction of the main emission direction of the radiation-emitting units. “Immediately downstream” means, for example, that the primary lenses are arranged on and in mechanical contact with the radiation-emitting units.

According to at least one embodiment, the LEDs are at least partially embedded in the primary lenses. For example, the LEDs are form-fittingly surrounded by the primary lenses. Particularly, the primary lenses are formed around the LEDs assigned thereto. With this, a higher coupling efficiency can be achieved and stray light can be eliminated.

According to at least one embodiment, at least some optical elements of the projection arrangement are embedded in a cover layer so that the cover layer form-fittingly surrounds the optical elements at least in places. For example, all lenses of a lens array, particularly primary lenses, are embedded in the cover layer. The cover layer may be a contiguous layer. The cover layer is, in particular, a transparent layer.

According to at least one embodiment, the cover layer and the optical elements embedded therein are formed of a polymer, particularly of a photopolymer. For example, the optical elements and the cover layer are both based on polymers having the same basic structure. For example, the polymers of the optical elements and of the cover layer are different from each other only by one monomer of the polymer. The cover layer and the optical elements embedded therein are, for example, formed in one piece, from a common layer of a starting material.

According to at least one embodiment, the cover layer and the optical elements embedded therein have different refractive indices. Particularly, the optical elements have a higher reflective index than the cover layer. The refractive index of the optical elements may deviate from the refractive index of the cover layer by at least 0.01 or at least 0.015. The refractive index hereby means the refractive index for the radiation of the radiation-emitting device and/or for radiation in the visible range, for example at 500 nm wavelength.

According to at least one embodiment, at least some of the projection channels, for example all projection channels, are each assigned at least two radiation-emitting units of the radiation-emitting device such that radiation from the at least two assigned radiation-emitting units is at least predominantly, e.g. completely, incident on or into the respective projection channel. Thus, with the help of the projection arrangement, radiation from two different radiation-emitting units are projected into the same area of the surface, i.e. together form one pixel of the image.

Using a projector in which the projection channels are each assigned two or more radiation-emitting units can help to increase the brightness of the projected image.

Next, the method for producing optical elements for a projector is specified. The method may be used for producing optical elements as described in connection with the projector. Therefore, all features described for the projector are also disclosed for the method and vice versa.

According to at least one embodiment, the method for producing optical elements for a projector comprises a step of providing a starting material. The starting material is, for example, provided in a liquid or gel-like phase. The starting material is, in particular, an organic material, for example a photopolymer.

According to at least one embodiment, the method comprises performing a treatment process in which the starting material is locally structurally changed in order to define optical elements for the projector. Structurally changing means that the material structure is changed. For example, the starting material is locally cured and/or locally cross-linked. The starting material is, for example, structurally changed only in those regions which are intended to form the optical elements. For example, the starting material is locally structurally changed in order to form a microlens array with a plurality of microlenses.

According to at least one embodiment, the method comprises a step of introducing particles into the starting material. For example, the particles are diffused into the remaining starting material.

According to at least one embodiment, the particles have a different, particularly lower, refractive index than the starting material. This particularly refers to the refractive index of the structurally changed starting material. For example, the refractive index of the particles differs from the refractive index of the starting material by at least 0.05 or at least 0.1. For example, the refractive index of the starting material is between 1.4 and 1.7 inclusive, e.g. between 1.5 and 1.65 inclusive. The refractive index of the particles may be between 1.3 and 1.6 inclusive, for example between 1.4 and 1.5 inclusive.

According to at least one embodiment, the particles are accommodated differently in the starting material which has been structurally changed in the treatment process than in the remaining starting material. For example, less particles are accommodated in the structurally changed starting material. After introducing the particles, the concentrations of the particles in the structurally changed starting material and the remaining starting material may differ by at least a factor of 100 or at least 1000. For example, the particles do not penetrate, or only negligibly penetrate, into the starting material which has been structurally changed in the treatment process.

According to at least one embodiment, the method comprises performing a further treatment process (also called second treatment process) in which the remaining starting material, which was not structurally changed in the treatment (also called first treatment process), is structurally changed. Thus, the remaining starting material which, for example comprises the incorporated particles, is structurally changed, e.g. cured and/or cross-linked. The further treatment process is performed after the incorporation of the particles.

The remaining starting material, being structurally changed in the second treatment process, remains as a cover (layer) on the optical elements. For example, the optical elements are then embedded in the cover. Accordingly, the cover forms part of the final projector. Due to the difference in the refractive index of the particles and the starting material, the optical elements and the cover have different refractive indices. Thus, when radiation passes from the optical elements into the cover, refraction appears.

The described method allows the production of very small optical elements, like microlenses, out of a starting material. The starting material, which is not structurally changed in first treatment process, does not have to be washed away. Rather, its refractive index is changed by incorporating particles so that a sufficient refractive index difference appears between the optical elements and the surrounding medium (cover). Dismissing the step of washing away the remaining starting material reduces the risk of damage to the optical elements and further allows even smaller optical elements to be produced.

According to at least one embodiment, the starting material is applied to a radiation-emitting device having a plurality of radiation-emitting units each being configured to emit radiation. For example, the starting material is applied in a liquid or gel-like phase to the radiation-emitting device. Thereby, the radiation-emitting device, particularly the LEDs thereof, may be surrounded or embedded in the starting material.

According to at least one embodiment, during the treatment process, the starting material is structurally changed such that at least some optical elements, for example each optical element, is each uniquely assigned to a radiation-emitting unit, e.g. on a one-to-one basis. For example, in the first treatment process, the starting material is structurally changed such that the resulting optical elements are formed directly on top of and/or around the assigned radiation-emitting units, e.g. on top of and/or around the LED(s) assigned to the radiation-emitting units.

According to at least one embodiment, the optical elements comprise primary lenses, for example primary microlenses, which are formed immediately downstream of the radiation-emitting units.

According to at least one embodiment, each radiation-emitting unit is assigned at least one LED.

According to at least one embodiment, the LEDs are embedded in the optical elements.

Instead of applying the starting material on a radiation emitting-device, the starting material may be applied onto a substrate, e.g. a transparent substrate. The treatment processes may then be performed with the starting material on that substrate. The finally produced optical elements may remain on the substrate. Accordingly, the substrate may constitute part of the final projector.

According to at least one embodiment, in the treatment process, the starting material is locally structurally changed, for example cross-linked, by means of laser writing. Particularly, the (first) treatment process is a two-photon lithography process. The used laser may be impinged on the starting material and may emit ultrashort pulses of about 100 fs. The wavelength of the laser is 780 nm, for example. The repetition rate of the laser may be 80 MHz.

In the further treatment process, the remaining starting material is, for example, heated and/or exposed to radiation, like UV-radiation. In this step, the particles in the remaining starting material and the remaining starting material are cross-linked, for example.

According to at least one embodiment, the starting material is a polymer or an oligomer, particularly a photopolymer. The starting material may be based on epoxy. For example, a main component of the starting material is an oligomer based on a bisphenol-A diglycidylether. Additionally, it may comprise γ-butyrolactone (GBL) solvent.

According to at least one embodiment, the particles are monomers. For example, the monomers are diffused into the starting material from the gas phase. The particles may be aliphatic monomers.

Hereinafter, the projector and the method will be explained in more detail with reference to the drawings on the basis of exemplary embodiments. The accompanying figures are included to provide a further understanding. In the figures, elements of the same structure and/or functionality may be referenced by the same reference signs. It is to be understood that the embodiments shown in the figures are illustrative representations and are not necessarily drawn to scale. In so far as elements or components correspond to one another in terms of their function in different figures, the description thereof is not repeated for each of the following figures. For the sake of clarity, elements might not appear with corresponding reference symbols in all figures.

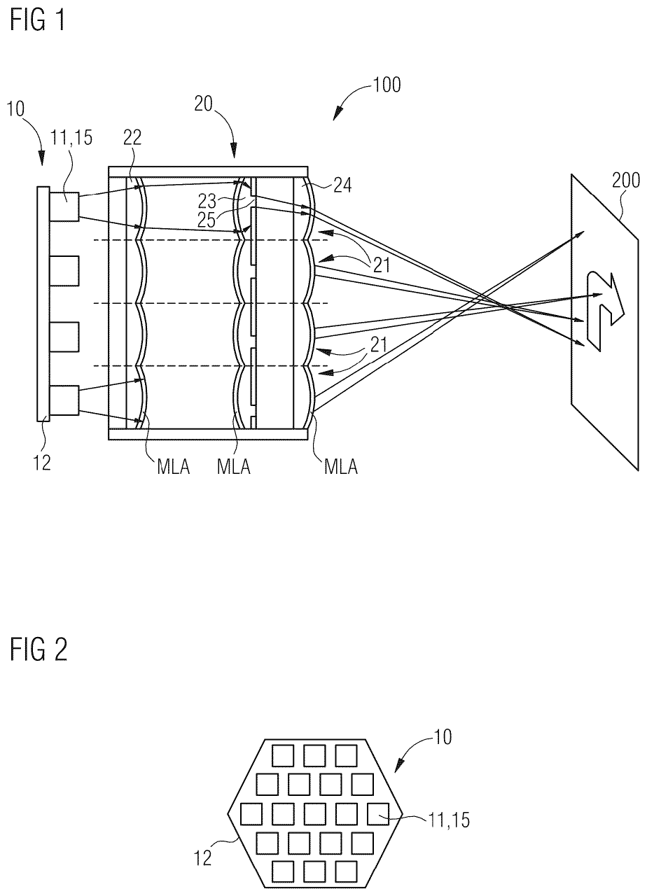

FIGS. 1, 3 and 10 show exemplary embodiments of the projector,

FIG. 2 shows an exemplary embodiment of a radiation-emitting device in plan view,

FIGS. 4 to 9 show different positions in an exemplary embodiment of the method for producing optical elements for a projector.

FIG. 1 shows a first exemplary embodiment of the projector 100. The projector 100 comprises a radiation-emitting device 10 and a projection arrangement 20.

The radiation-emitting device 10 comprises a carrier 12 on top of which a plurality of LEDs 15 is arranged. Each LED 15 is, for example, configured to emit visible light, for example white light. Each LED 15 constitutes a radiation-emitting unit 11 of the radiation-emitting device 10. For example, the LEDs 15 and, hence, the radiation-emitting units 11 are individually and independently controllable so that each LED 15 or radiation-emitting unit 11, respectively, can emit radiation independently of the other LEDs 15 or radiation-emitting units 10. For this purpose, the carrier 12 may comprise a plurality of switches (not shown), wherein each switch is assigned to a LED 15 and each switch is configured to turn the respective LED 15 on or off. The switches may be thin-film-transistors. For example, the projector is completely programmable so that it is configured to produce various and arbitrary images by varying the control of the radiation-emitting units 11.

The projection arrangement 20 is configured to project the radiation emitted by the radiation-emitting device 10 onto a surface 200. By way of example, the projector 100 is installed in a car, and, when a door of the car is opened, the projector 100 projects the image generated by the radiation-emitting device 10 onto the street directly adjacent to the car.

The projection arrangement 20 comprises a plurality of projection channels 21, wherein each projection channel 21 is uniquely assigned a radiation-emitting unit 11 or LED 15, respectively. The radiation emitted by the respective radiation-emitting unit 11 is predominantly or completely incident on the projection arrangement 20 in the area of the assigned projection channel 21. The projection channels 21 each guide the incident radiation and project the radiation onto a predefined area on the surface 200. In FIG. 1, the virtual border between each two adjacent projection channels 21 is indicated by a dashed line.

By changing the control of the radiation-emitting units, different images can be projected onto the surface 200. This may be done without changing the projection arrangement 20 itself. The projection arrangement 20 is, in particular, static.

In the exemplary embodiment of FIG. 1, the projection arrangement 20 comprises three microlens arrays MLA comprising a plurality of microlenses 22, 23, 24. In each microlens array MLA, the respective microlenses are connected to each other. A first microlens array MLA comprises primary lenses 22, a second microlens array MLA comprises second microlenses 23 and a third microlens array comprises third microlenses 24. The microlens arrays are arranged one after the other.

Each projection channel 21 has a primary lens 22, a second lens 23 and a third lens 24 of the three microlens arrays MLA assigned thereto. Moreover, each projection channel 21 has an optical aperture 25 assigned thereto. The primary lenses 22 are arranged on a substrate. The substrate and the primary lenses 22 are made from a transparent material, like glass or plastic. The second lenses 23 and the third lenses 24 are arranged on different sides of a further substrate. Also the second lenses 23 and third lenses 24 lens as well as the further substrate are made of a transparent material, like glass or plastic. Furthermore, an opaque layer, e.g. of chrome, is formed on the further substrate. A plurality of openings is formed in the opaque layer and each opening constitutes an optical aperture 25.

The primary lenses 22 focus the radiation of the assigned radiation-emitting units 11 onto the second lenses 23. The second lenses 23 further focus the radiation onto the apertures 25. The radiation passing through the apertures 25 is then directed to the predefined certain area on the surface 200 with the help of the third lenses 24. The path of different rays of the uppermost radiation-emitting unit 11 is indicated in FIG. 1.

FIG. 2 shows a plan view of an exemplary embodiment of a radiation-emitting device 10, e.g. of the radiation-emitting device 10 of FIG. 1. The radiation-emitting units 11 are arranged in a two-dimensional pattern on the carrier 12. The lenses of the different microlens arrays may be arranged in a corresponding two-dimensional pattern.

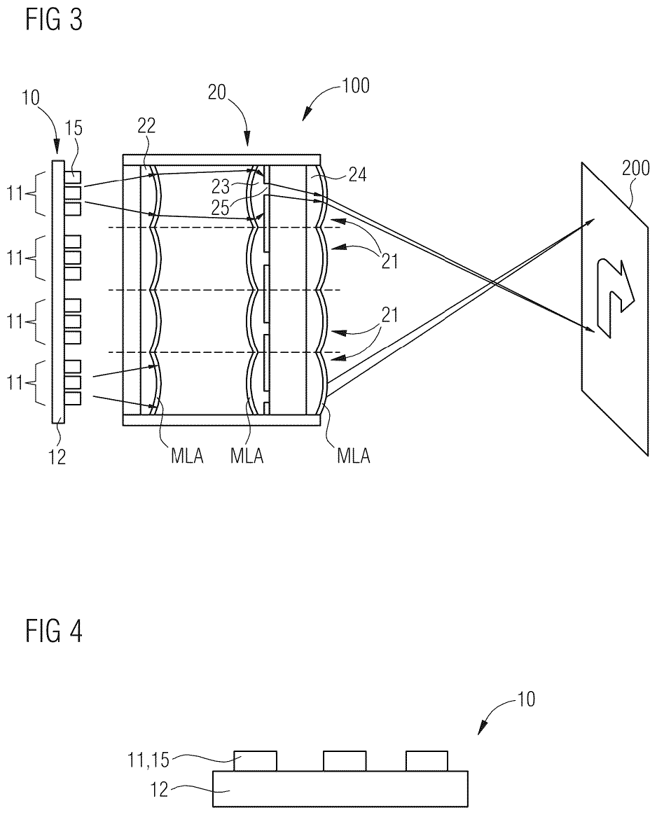

FIG. 3 shows a second exemplary embodiment of the projector 100. The projector 100 of FIG. 3 is similar to that of FIG. 1. In contrast to the first exemplary embodiment, however, each radiation-emitting unit 11 is here realized by three LEDs 15. The three different LEDs 15 of each radiation-emitting unit 11 are configured to emit radiation of different colors. For example, one LED is, in each case, configured to emit blue light, one LED 15 is, in each case, configured to emit green light and one LED 15 is, in each case, configured to emit red light. The different LEDs 15 of each radiation-emitting unit 11 may be independently controllable so that the color of the light emitted by each radiation-emitting unit 11 can be controlled.

FIG. 4 shows a first position in an exemplary embodiment of the method for producing optical elements for a projector. A radiation-emitting device 10, e.g. the radiation-emitting device 10 as described in connection with FIG. 1, is provided.

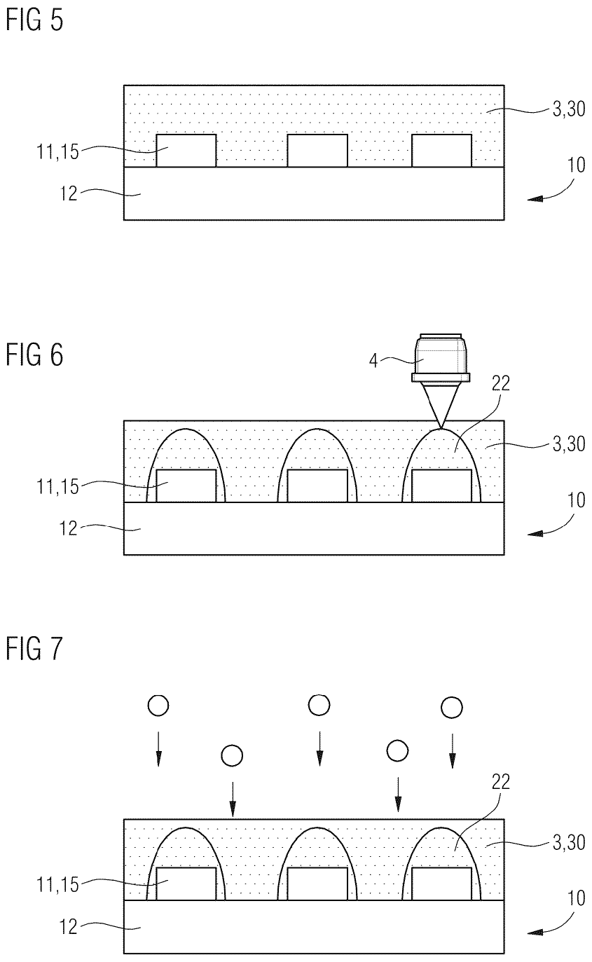

In a further position, shown in FIG. 5, a layer 3 of a starting material 30 is applied onto the carrier 12 so that the LEDs 15 are embedded in the starting material 30. The starting material 30 is, for example, a photopolymer based on epoxy. It may be applied to the carrier 12 in a liquid or gel-like phase. A main component of the starting material 30 is, for example, an oligomer based on a bisphenol-A diglycidylether. Additionally, it may comprise γ-butyrolactone (GBL) solvent which allows for the forming of defect-free films by spin-coating. The starting material may be transparent at 780 nm but sensitive to 365 nm light. After application to the carrier 12, the starting material 30 may be heated for several hours.

In the position of FIG. 6, optical elements 22 are written into the starting material 30 by means of laser writing.

Laser light from a laser 4 is impinged onto the starting material 30. Due to two photon absorption, the starting material 30 is locally structurally changed, for example cross-linked, so that the optical elements 22 are defined.

The laser 4 may emit radiation of a wavelength of 780 nm. The laser intensity is, for example between 5 mW and 40 mW. In the present case, the optical elements 22 are primary lenses 22 which surround the LEDs 15. The rest of the starting material 30 is not structurally changed.

In the position of FIG. 7, particles are incorporated into the remaining starting material 30. The particles are aliphatic monomers which have a different refractive index than the starting material 30, e.g. a smaller refractive index. The monomers are diffused into the starting material 30 from the gas phase. The monomers diffuse into the remaining starting material 30 but do not reach into the structurally changed starting material 30 defining the lenses 22. As a consequence of this, the optical elements 22 or the structurally changed starting material 30 thereof, respectively, have a higher refractive index than the remaining starting material 30 with the incorporated monomers. For example, the difference in the refractive index of the different regions is 0.016.

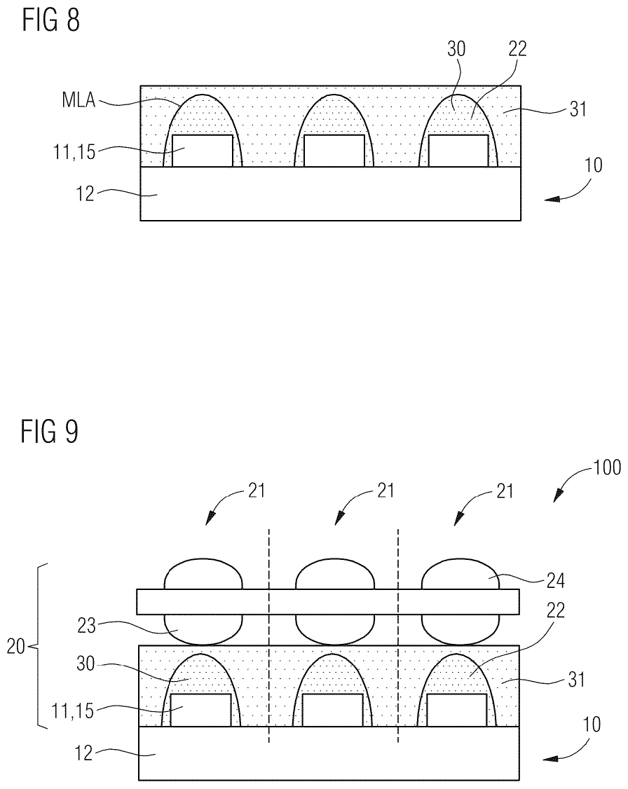

In the position of FIG. 8, a further treatment process is performed in which the remaining starting material 30 comprising the monomers is structurally changed, for example cured. This may be done by heating and/or treatment with UV radiation. Thereby, the remaining starting material 30 is cross-linked and a cover layer 31 is formed in which the microlenses 22 are embedded. Due to the difference in the refractive index between the lenses 22 and the cover layer 31, radiation generated by the LEDs 15 is refracted at the interface between the optical elements 22 and the cover layer 31 thereby giving the lenses 22 their functionality of focusing or dispersing the radiation. The first lenses 22 of FIG. 8 constitute a microlens array, for example.

In the position of FIG. 9, further optical elements in the form of second lenses 23 and third lenses 24 are applied so that a projection arrangement 20 is formed onto the radiation-emitting device 10 which, for example, projects the light of the LEDs 15 as described in connection with FIGS. 1 and 3.

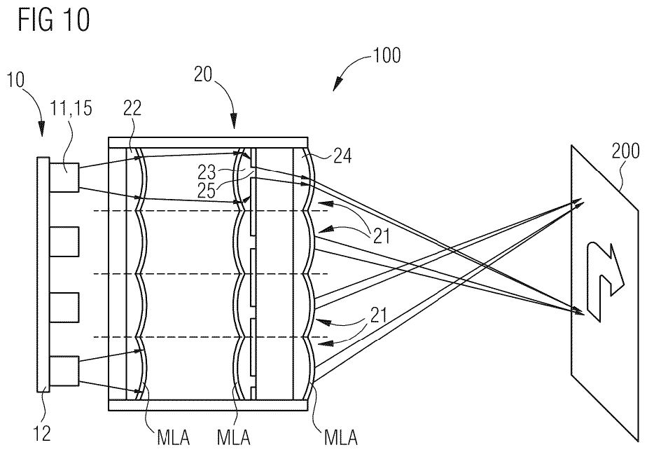

FIG. 10 shows a third exemplary embodiment of the projector 100. In contrast to the previous exemplary embodiments, each projection channel 21 are assigned two or more radiation-emitting units. As a consequence, radiation from these radiation-emitting units 11 is projected onto the same predefined area on the surface 200. Therefore, the brightness is increased.

This patent application claims priority to German patent application 102022120429.4, the disclosure content of which is hereby incorporated by reference.

The invention described herein is not limited by the description in conjunction with the exemplary embodiments.

Rather, the invention comprises any new feature as well as any combination of features, particularly including any combination of features in the patent claims, even if said feature or said combination per se is not explicitly stated in the patent claims or exemplary embodiments.

### REFERENCES

4 laser
10 radiation-emitting device
10′ further radiation-emitting device
11 radiation-emitting unit
12 carrier
15 LED
20 projection arrangement
21 projection channel
22 primary lenses
23 second lens
24 third lens
25 optical aperture
26 semitransparent mirror
30 starting material
31 cover layer 31
100 projector
200 surface
MLA microlens array

1. A projector for projecting an image onto a surface comprising
a radiation-emitting device having a plurality of radiation-emitting units, and
a projection arrangement for projecting the radiation emitted by the radiation-emitting device onto the surface, wherein
the radiation-emitting units are each configured to emit radiation when operated,
the projection arrangement comprises a plurality of projection channels, each projection channel having at least one optical element for beam shaping,
each projection channel is configured to project radiation incident on the projection channel into a certain area of the surface,
at least some radiation-emitting units of the radiation-emitting device are each uniquely assigned to a projection channel such that radiation from the assigned radiation-emitting unit is at least predominantly incident on the respective projection channel,
at least some radiation-emitting units are controllable independently of other radiation-emitting units so that different images can be projected onto the surface by changing the control of the radiation-emitting units without changing the projection arrangement.

2. The projector according to claim 1, wherein
the projection arrangement comprises a microlens array,
at least some of the radiation channels each have a microlens, of the microlens array uniquely assigned thereto.

3. The projector according to claim 2, wherein
the projection arrangement comprises at least two microlens array arranged one after the other,
at least some projection channels each have at least two microlenses of different microlens arrays uniquely assigned thereto and arranged one after the other.

4. The projector according to claim 1, wherein
the projection arrangement comprises several optical apertures,
at least some of the projection channels each have an optical aperture uniquely assigned thereto.

5. The projector according to claim 1, wherein
the radiation-emitting device comprises a plurality of LEDs,
each LED is uniquely assigned to a radiation-emitting unit.

6. The projector according to claim 5, wherein
the LEDs are μLEDs.

7. The projector according to claim 5, wherein
at least two LEDs are uniquely assigned to each radiation-emitting unit,
the at least two LEDs are configured to emit different types of radiation.

8. The projector according to claim 1, wherein
each radiation-emitting unit is independently controllable of the other radiation-emitting units so that it can emit radiation independently from the other radiation-emitting units.

9. The projector according to claim 1, wherein
the projection arrangement is static and a variation of the projected image is achieved by a variation of the control of the radiation-emitting units.

10. The projector according to claim 1,
wherein the projection arrangement comprises a plurality of primary lenses,
each primary lens is assigned a radiation-emitting unit,
the primary lenses are arranged immediately downstream of the assigned radiation-emitting units.

11. The projector of claim 1, wherein
the radiation-emitting device comprises a plurality of LEDs,
each LED is uniquely assigned to a radiation-emitting unit,
the LEDs are at least partially embedded in the primary lenses.

12. The projector according to claim 1, wherein
at least some optical elements are embedded in a cover layer,
the cover layer and the optical elements embedded therein are formed of a polymer,
the cover layer and the optical elements embedded therein have different refractive indices.

13. The projector according to claim 1, wherein
at least some of the projection channels are each assigned two different radiation-emitting units such that radiation from the at least two assigned radiation-emitting units is at least predominantly incident on the respective projection channel.

14. A method for producing optical elements for a projector, comprising:
providing a starting material;
locally structurally changing the starting material in a treatment process in order to define optical elements for the projector; and
introducing particles into the starting material, wherein
the particles have a different refractive index than the starting material,
the particles are accommodated differently in the starting material which has been structurally changed in the treatment process than in the remaining starting material.

15. The method according to claim 14, further comprising
structurally changing the remaining starting material in a further treatment process.

16. The method according to claim 14, wherein
the starting material is applied to a radiation-emitting device having a plurality of radiation-emitting units each being configured to emit radiation,
during the treatment process, the starting material is structurally changed such at least some optical elements are each uniquely assigned to a radiation-emitting unit.

17. The method according to claim 14, wherein
each radiation-emitting unit is assigned at least one LED,
said LEDs are embedded in the optical elements.

18. The method according claim 14, wherein
in the treatment process, the starting material is locally structurally changed by means of laser writing.

19. The method according to claim 14, wherein
the starting material is a polymer,
the particles are monomers which are diffused into the starting material from the gas phase.

20. A projector for projecting an image onto a surface comprising
a radiation-emitting device having a plurality of radiation-emitting units, and
a projection arrangement for projecting the radiation emitted by the radiation-emitting device onto the surface, wherein
the radiation-emitting units are each configured to emit radiation when operated,
the projection arrangement comprises a plurality of projection channels, each projection channel having at least one optical element for beam shaping,
each projection channel is configured to project radiation incident on the projection channel into a certain area of the surface,
at least some radiation-emitting units of the radiation-emitting device are each uniquely assigned to a projection channel such that radiation from the assigned radiation-emitting unit is at least predominantly incident on the respective projection channel,
at least some radiation-emitting units are controllable independently of other radiation-emitting units so that different images can be projected onto the surface by changing the control of the radiation-emitting units without changing the projection arrangement,
the projection arrangement comprises at least two microlens array arranged one after the other,
at least some projection channels each have at least two microlenses of different microlens arrays uniquely assigned thereto and arranged one after the other.
